(19) United States
(12) Patent Application Publication
(10) Pub. No.: US 2024/0293875 A1
(43) Pub. Date: Sep. 5, 2024

(54) CUTTING TOOL

(71) Applicant: MILWAUKEE ELECTRIC TOOL CORPORATION, Brookfield, WI (US)

(72) Inventors: Chris J. Rechlin, Menomonee Falls, WI (US); Austin J. Kazda, Wauwatosa, WI (US)

(21) Appl. No.: 18/578,416

(22) PCT Filed: Jul. 19, 2022
(86) PCT No.: PCT/US2022/073895

§ 371 Date: Jan. 11, 2024

Related U.S. Application Data
(60) Provisional application No. 63/223,935, filed on Jul. 20, 2021.

(51) Int. Cl. B23B 51/04

(52) U.S. Cl. CPC B23B 51/0473

(57) ABSTRACT

An arbor assembly for a hole saw and a pilot bit including a shank having a first end, a second end, and a longitudinal axis extending between the ends. The shank includes a groove and an aperture. The aperture positioned between the groove and the second end. The arbor assembly includes a sleeve moveable relative to the shank and a locking member. The locking member secures the hole saw to the arbor assembly. The arbor assembly includes a retaining ring to limit the axial movement of the sleeve and a fastener received in the aperture. The fastener is configured to secure the pilot bit to the arbor assembly. The sleeve is moveable relative to the shank between a first position, where the locking member secures the hole saw to the arbor assembly, and a second position, where the locking member releases the hole saw from the arbor assembly.

### CROSS REFERENCE TO RELATED APPLICATIONS

This application claims priority to co-pending U.S. Provisional Patent Application No. 63/223,935, filed Jul. 20, 2021, the entire contents of which are incorporated herein by reference.

### BACKGROUND

The present invention relates to arbor assemblies and, more particularly, to quick-release arbor assemblies for cutting tools or hole saws.

Typically, a hole saw is coupled to a rotating power tool using an arbor assembly. The arbor assembly generally includes a shank and an arbor. Some hole saw arbor assemblies include mechanisms to help quickly release and attach hole saws.

### SUMMARY

In one embodiment, the invention provides an arbor assembly for a hole saw and a pilot bit. The arbor assembly includes a shank having a first end operable to be coupled to a power tool, a second end opposite the first end, and a longitudinal axis extending between the first and second ends. The shank also includes a groove and an aperture. The aperture is positioned between the groove and the second end. The arbor assembly also includes a sleeve moveable relative to the shank along the longitudinal axis and a locking member supported by the shank. The locking member is configured to engage a hole saw or an adapter of the hole saw to selectively secure the hole saw to the arbor assembly. The arbor assembly further includes a retaining ring supported by the groove of the shank to limit the axial movement of the sleeve relative to the shank and a fastener at least partially received in the aperture. The fastener is configured to secure the pilot bit to the arbor assembly. The sleeve is moveable relative to the shank between a first position, where the locking member secures the hole saw to the arbor assembly, and a second position, where the locking member releases the hole saw from the arbor assembly.

In another embodiment, the invention provides a system including a first hole saw having a first cutting end and a first connection end opposite the first cutting end. The first hole saw having a first diameter that is equal to or greater than 2.0 inches. The system also includes a first adapter coupled to the first connection end of the first hole saw and a second hole saw including a second cutting end and a second connection end opposite the second cutting end. The second hole saw defines a second diameter that is equal to or less than 1¼ inches. The system further includes a second adapter coupled to the second connection end of the second hole saw and an arbor assembly. The arbor assembly includes a shank having a first end operable to be coupled to a power tool, a second end opposite the first end, and a longitudinal axis extending between the first and second ends. The second end is alternately connectable to the first adapter and the second adapter. The arbor assembly also includes a sleeve moveable relative to the shank and a locking member movable in response to movement of the sleeve. The locking member selectively engages the first adapter when the first adapter is connected to the shank to secure the first hole saw to the arbor assembly, and selectively engages the second adapter when the second adapter is connected to the shank to secure the second hole saw to the arbor assembly. The system also includes a pilot bit coupled to the shank. The pilot bit extends past the first cutting end when the first adapter is coupled to the arbor assembly, and wherein the pilot bit extends past the second cutting end when the second adapter is coupled to the arbor assembly.

In another embodiment, the invention provides a cutting tool including a hole saw and an adapter coupled to the hole saw. The adapter includes a first end, a second end opposite the first end, a longitudinal axis extending between the first and second ends, and a flange separating the first end from the second end. The adapter defines an overall length measured in a direction parallel to the longitudinal axis between the first and second ends. The flange defines a width measured in a direction parallel to the longitudinal axis. The cutting tool also includes an arbor assembly with a shank having a first end configured to be coupled to a power tool and a second end opposite the first end. The second end couples to the adapter. The cutting tool also includes a sleeve moveable relative to the shank between a first position, in which the adapter is secured to the arbor assembly, and a second position, in which the adapter is removable from the arbor assembly. A ratio between the overall length of the adapter to the width of the flange is between 6 and 10.

In another embodiment, the invention provides an arbor assembly for a hole saw. The arbor assembly includes a shank having a first end configured to be coupled to a power tool, a second end opposite the first end, and a longitudinal axis extending between the first and second ends. The second end is configured to be coupled to the hole saw. The arbor assembly also includes a sleeve moveable relative to the shank along the longitudinal axis between a first position, in which the hole saw is secured to the arbor assembly, and a second position, in which the hole saw is removable from the arbor assembly. The sleeve includes a body and a drive pin extending from the body. The drive pin is configured to be received within an aperture of the hole saw. The body defining an overall length measured in a direction parallel to the longitudinal axis. The drive pin defining a height measured in a direction parallel to the longitudinal axis. A ratio between the overall length of the body to the height of the drive pin is greater than or equal to 10.

Other aspects of the invention will become apparent by consideration of the detailed description and accompanying drawings.

### BRIEF DESCRIPTION OF THE DRAWINGS

FIG. 1 is a plan view of a cutting tool.

FIG. 2 is an exploded view of the cutting tool of FIG. 1.

FIG. 3 is a cross-sectional view of the cutting tool of FIG. 1.

FIG. 4 is another cross-sectional view of the cutting tool of FIG. 1.

FIG. 5 is a perspective view of an adapter according to another embodiment for use with the cutting tool of FIG. 1.

FIG. 6 is a plan view of the adapter of FIG. 1.

FIG. 7 illustrates several views of an adapter according to another embodiment for use with the cutting tool of FIG. 1.

FIG. 8 illustrates several views of a shank according to another embodiment for use with the cutting tool of FIG. 1.

FIG. 9 is a perspective view of a sleeve according to another embodiment for use with the cutting tool of FIG. 1.

FIG. 10 illustrates several views of a sleeve according to another embodiment for use with the cutting tool of FIG. 1.

FIG. 11 is a plan view of a cutting tool according to another embodiment.

FIG. 12 is a plan view of a cutting tool according to another embodiment.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

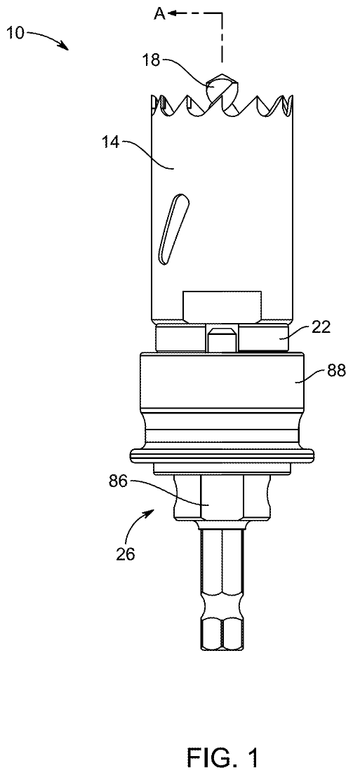

FIG. 1 illustrates a cutting tool 10 for performing a cutting operation on a workpiece. The cutting tool 10 includes a hole saw 14, a pilot bit 18, an adapter 22, and an arbor assembly 26. Both the hole saw 14 and the pilot bit 18 are removably coupled to the arbor assembly 26. Thus, the arbor assembly 26 allows different types and/or sizes of hole saws and pilot bits to be interchangeably coupled to the arbor assembly 26. Furthermore, if one part should fail first (e.g., the arbor assembly 26, the pilot bit 18, or the hole saw 14), a user can remove and replace that part instead of needing to throw away the entire cutting tool 10. In some embodiments, the pilot bit 18 may be omitted such that the cutting tool 10 only includes the hole saw 14 and the arbor assembly 26.

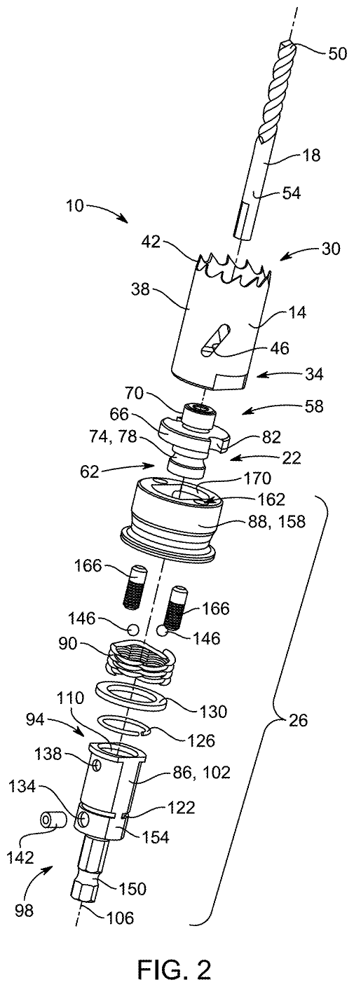

With reference to FIG. 2, the hole saw 14 includes a cutting end 30, a connection end 34 opposite the cutting end 30, and a cylindrical wall 38 extending between the cutting end 30 and the connection end 34. The cutting end 30 includes a toothform 42 circumferentially spaced about the wall 38 that cuts through the workpiece. In the illustrated embodiment, the toothform 42 is defined by a repeating pattern of cutting teeth and gullets. In other embodiments, the toothform 42 may have other configurations. At least one opening 46 is formed in the wall 38 of the illustrated hole saw 14 between the cutting end 30 and the connection end 34 to facilitate chip and plug removal form the hole saw 14. Although not shown, the hole saw 14 includes an end cap coupled to the connection end 34. The end cap may include one or more apertures that threadably connect the hole saw 14 to the adapter 22 as will be discussed in more detail below. The hole saw 14 may be a one of a variety of different size hole saws. For example, the hole saw 14 may include a diameter that is 11/16″, 1⅛″, 1¼″, or 2 inches. In other embodiments, the hole 14 saw may include a diameter that is greater than or equal to 2.0 inches. In further embodiments, the hole 14 may include a diameter that is equal to or less than 1¼ inches. the hole saw 14 may also include a diameter between 1¼ and 2 inches.

The pilot bit 18 includes a cutting portion 50 and a shaft 54. The cutting portion 50 extends beyond the cutting end 30 of the hole saw 14 when the cutting tool 10 is assembled. The shaft 54 is received by the adapter 22 and the arbor assembly 26. In the illustrated embodiment, the pilot bit 18 is a twist drill bit. In other embodiments, the pilot bit 18 may be other types of drill bits, such as a spade bit. The hole saw 14 and the pilot bit 18 are both removable from the arbor assembly 26 separately or simultaneously.

The adapter 22 includes a first end 58, a second end 62 opposite the first end 58, and a flange 66 separating the first end 58 from the second end 62. The first end 58 defines a first boss 70 extending from the flange 66. The first boss 70 may include threads that correspond to the threads of the end cap to secure the hole saw 14 to the adapter 22. As such, the hole saw 14 is removably coupled to the adapter 22. The second end 62 defines a second boss 74 extending from the flange 66 in an opposite direction as the first boss 70. The second boss 74 includes a positioning groove 78 extending circumferentially about the second boss 74. The flange 66 defines two semi-circular recesses 82. A bore 80 extends centrally through the adapter 22 between the first and second ends 58, 62.

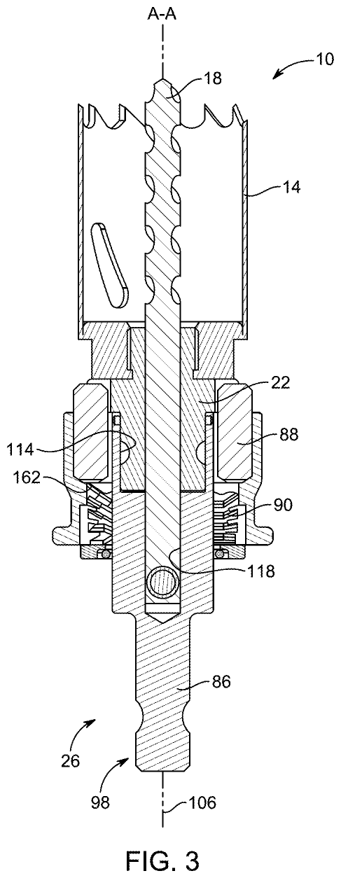

With continued reference to FIG. 2, the arbor assembly 26 includes a shank 86, a sleeve 88 that is axially moveable relative to the shank 86, and a spring 90. The shank 86 includes a first end 94, a second end 98 opposite the first end 94, and a body 102 between the first and second ends 94, 98. The shank 86 also defines a longitudinal axis 106 extending through the first and second ends 94, 98. The longitudinal axis 106 also extends centrally through the adapter 22, the hole saw 14, and the arbor assembly 26. The first end 94 defines a bore 110 that extends partially into the body 102 of the shank 86. The bore 110 includes a first portion 114 and a second portion 118 adjacent the first portion 114 (FIG. 3). The first portion 114 defines a first diameter and is configured to receive the adapter 22. The second portion 118 defines a second diameter that is smaller than the first diameter and is configured to receive the pilot bit 18. The body 102 includes a groove 122 that supports a retaining ring 126 and a washer 130. The washer 130 defines a spring seat that supports the spring 90 and the retaining ring 126 acts as a stop to limit the axial movement of the sleeve 88 relative to the shank 86. The body 102 of the shank 86 also defines a set screw aperture 134 and a pair of detent apertures 138 (although only one is shown in FIG. 2). The set screw aperture 134 is configured to receive a fastener (e.g., a set screw 142) that secures the pilot bit 18 within the second portion 118 of the bore 110. In some embodiments, the pilot bit 18 may be secured to the arbor assembly 26 in other ways. In other embodiments, the pilot bit 18 may be integrally formed with the shank 86. The detent apertures 138 extend into the first portion 114 of the bore 110 and are both configured to support a locking member (i.e., ball detents 146). In the illustrated embodiment, the set screw aperture 134 is positioned between the groove 122 and the second end 98 of the shank 86.

The second end 98 of the shank 86 is configured to be coupled to the power tool. In the illustrated embodiment, the second end 98 includes a hex-shaped shaft having an annular groove 150 that is configured to be received in and engaged by a chuck of the power tool. In other embodiments, the second end 98 may include other suitable shafts or coupling mechanisms for connecting to a power tool.

The body 102 is generally cylindrical, but includes one or more flat surfaces 154. The flat surfaces 154 inhibit the sleeve 88 from rotating relative to the shank 86. In the illustrated embodiment, the body 102 includes two flat surfaces 154 on opposing sides of the body 102. In other embodiments, the body 102 may include a single flat surface 154 or may include more than two flat surfaces 154.

The sleeve 88 is supported by the shank 86 and movable relative thereto. In particular, the sleeve 88 is slidable along the shank 86 in a direction parallel to the longitudinal axis 106. The sleeve 88 includes a generally cylindrical body 158, a central bore 162, and a pair of drive pins 166 extending from the body 158. In the illustrated embodiment, the drive pins 166 are removably coupled to the sleeve 88. In other embodiments, the drive pins 166 are integral with the sleeve 88. The drive pins 166 extend through the recesses 82 of the adapter 22. In addition, the drive pins 166 are received in corresponding apertures in the end cap of the hole saw 14 when the sleeve 88 engages the hole saw 14 to inhibit the hole saw 14 from being unthreaded from the adapter 22. The central bore 162 receives the shank 86 when the arbor assembly 26 is assembled. The cross-section of the central bore 162 is similar to the cross-section of the body 102 of the shank 86. As such, when the arbor assembly 26 is assembled, relative rotation of the sleeve 88 to the shank 86 is inhibited. The sleeve 88 also includes a limiting groove 170 on the inside of the central bore 162. The limiting groove 170 is sized to receive the ball detents 146.

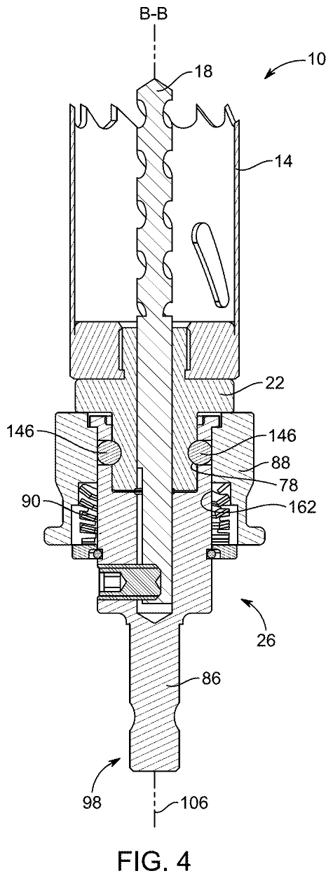

With reference to FIGS. 3 and 4, during operation of the cutting tool 10, the sleeve 88 is axially slidable along the longitudinal axis 106 relative to the shank 86 to secure the adapter 22 and hole saw 14 to the arbor assembly 26. Specifically, the sleeve 88 is a slidable between a first locked position (FIGS. 3 and 4), in which the sleeve 88 maintains the ball detents 146 into the positioning groove 78 of the adapter 22, and a second position (not shown), in which the ball detents 146 are allowed to disengage from the positioning groove 78 of the adapter 22. The spring 90 biases the sleeve 88 to the first position. A user may slide the sleeve 88 towards the second end 98 of the shank 86 against the bias of the spring 90. Once the limiting groove 170 of the sleeve 88 is positioned adjacent the ball detents 146 (i.e., the second position of the sleeve 88), the ball detents 146 retreat from the positioning groove 78 into the limiting groove 170 allowing the adapter 22 and hole saw 14 to be removed from the arbor assembly 26. Once the adapter 22 is removed, a different adapter 22 with a different hole saw 14 may be placed within the central bore 162 of the sleeve 88. A user may then release the sleeve 88 allowing the spring 90 to bias the sleeve 88 back to the first position, in which the ball detents 146 engage the positioning groove 78 of the new adapter 22 to secure the adapter 22 and hole saw 14 to the arbor assembly 26. As such, multiple sized hole saws may be placed on several adapters at once allowing for the quick change of different hole saws on the arbor assembly 26.

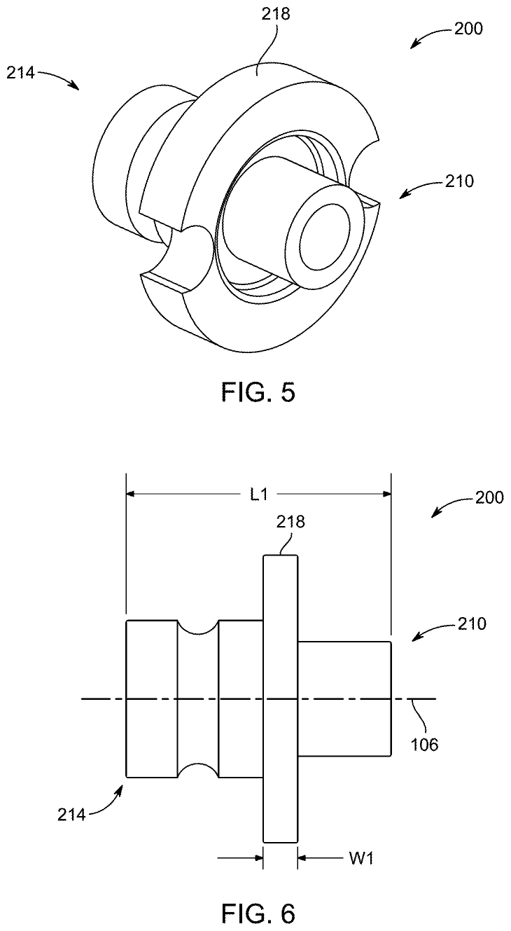

FIGS. 5 and 6 illustrate an adapter 200 according to another embodiment. The adapter 200 is similar to the adapter 22 discussed above, with like features being represented with like reference numbers. The adapter 200 includes a first end 210, a second end 214 opposite the first end 210, and a flange 218 separating the first and second ends 210, 214. The adapter 200 includes an overall length L1 measured in a direction parallel to the longitudinal axis 106 between the first and second ends 210, 214. The overall length L1 of the adapter 200 is shorter than the overall length of the adapter 22. In some embodiments, the length L1 of the adapter 200 is less than 1.0 inch. In other embodiments, the length L1 of the adapter 200 may be more than one inch. The flange 218 of the adapter 200 includes a width W1 measured in a direction parallel to the longitudinal axis 106. The width W1 of the flange 218 is less than the width of the flange 66 on the adapter 22 discussed above. In the illustrated embodiment, the width W1 of the flange 218 is between 0.1 inches and 0.2 inches. Specifically, the width W1 of the flange 218 is 0.125 inches. In other embodiments, the width W1 of the flange 218 may be smaller than 0.1 inches or greater than 0.2 inches. A ratio between the overall length L1 of the adapter 200 to the width W1 of the flange 218 is between 6 and 10. In other embodiments, the ratio between the overall length L1 of the adapter 200 to the width W1 of the flange 218 is between 7 and 9. In further embodiments, the ratio between the overall length L1 of the adapter 200 and the width W1 of the flange 218 is less than 6 or greater than 10.

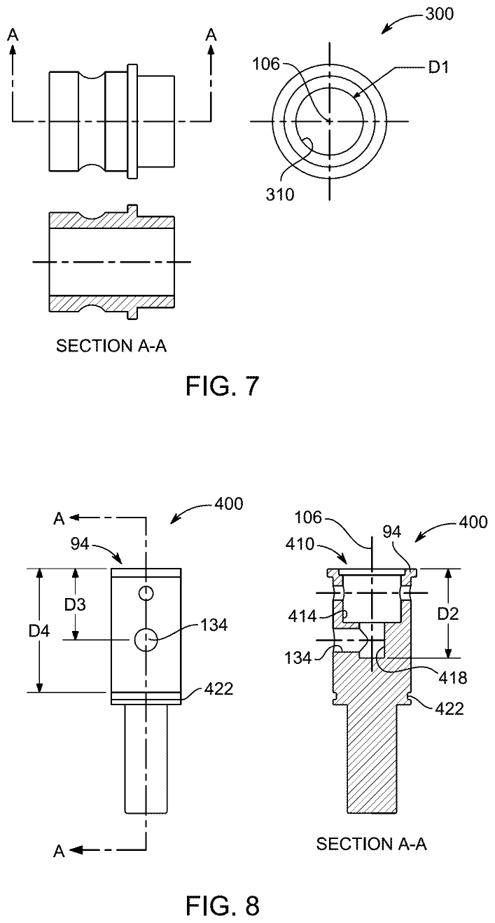

FIG. 7 illustrates an adapter 300 according to another embodiment of the invention. The adapter 300 is similar to the adapter 22 discussed above, with like features being represented with like reference numbers. The adapter 22 includes a bore 310 that defines a diameter D1 measured in a direction perpendicular to the longitudinal axis 106. The diameter D1 of the bore 310 is greater than a diameter of the bore 80 of the adapter 22 discussed above. In the illustrated embodiment, the diameter D1 of the bore 310 is between 0.35 inches and 0.45 inches. Specifically, the diameter D1 of the bore 310 is 0.4 inches. In other embodiments, the diameter D1 of the bore 310 may be less than 0.35 inches or greater than 0.45 inches.

FIG. 8 illustrates a shank 400 according to another embodiment of the invention. The shank 400 is similar to the shank 86 discussed above, with like features being represented with like reference number. The shank 400 includes a bore 410 having a first portion 414 and a second portion 418 adjacent the first portion 414. The first and second portions 414, 418 define a depth D2 measured in a direction parallel to the longitudinal axis 106 between the first end 94 of the shank 400 and the bottom of the second portion 418 of the bore 410. However, the depth D2 of the bore 410 is less than a depth of bore 110 of the shank 86. Specifically, the second portion 418 of the bore 410 that retains the pilot bit 18 includes a depth that is less than the depth of the second portion 118 of the shank 86 discussed above. In the illustrated embodiment, the overall depth D2 of the shank 400 is between 0.8 inches and 1.0 inches. Specifically, the depth D1 of the bore 410 is 0.9 inches. In other embodiments, the depth D1 of the bore 410 may be less than 0.8 inches or greater than 1.0 inches. Due to the shortened depth of the second portion 418 of the bore 410, the set screw aperture 134 is positioned closer to the first end 94 of the shank 400 than the set screw aperture 134 of the shank 86. Additionally, due to the shortened depth of the second portion 418 of the bore 410, the pilot bit 18 extends a further distance from the first end 94 of the shank 400.

The shank 400 also includes a groove 422 partially extending around the body 102 to support the retaining ring 130 and the washer 126. In the illustrated embodiment, the set screw aperture 134 is positioned between the groove 42 and the first end 94 of the shank 400. Specifically, the set screw aperture 134 is positioned a distance D3 from the first end 94 of the shank that is less than a distance D4 that the groove 422 is positioned from the first end 94 of the shank 86. In some embodiments, the distance D3 may be between 0.65 inches and 0.8 inches. In other embodiments, the distance D3 may be less than 0.65 inches or more than 0.8 inches. In some embodiments, the distance D4 may be between 1.2 inches and 1.3 inches. In other embodiments, the distance D4 may be less than 1.2 inches or more than 1.3 inches.

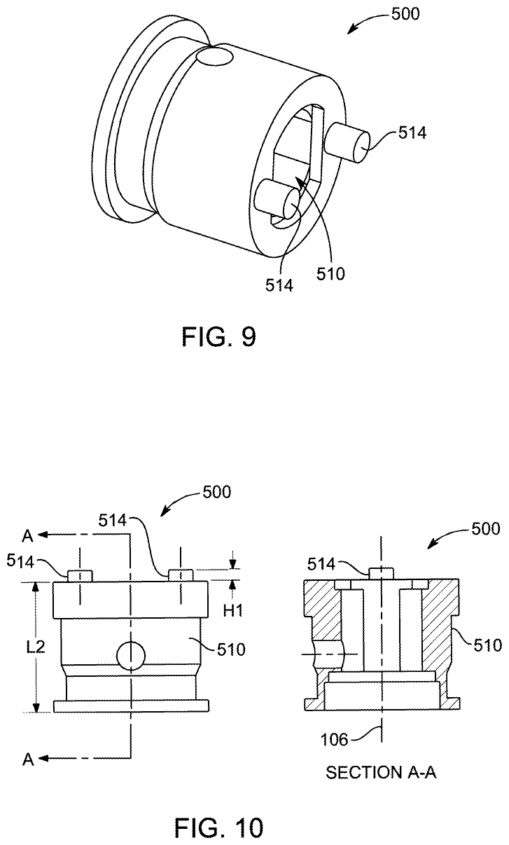

FIGS. 9 and 10 illustrate a sleeve 500 according to another embodiment of the invention. The sleeve 500 is similar to the sleeve 88 discussed above, with like features being represented with like reference numbers. The sleeve 500 includes a body 510 and drive pins 514 extending from the body 510. The body 510 includes an overall length L2 measured in a direction parallel to the longitudinal axis 106 that is greater than a length of the body 158 of the sleeve 88 discussed above. In the illustrated embodiment, the length L2 of the body 510 is between 1.15 inches and 1.45 inches. Specifically, the length L2 of the body 510 is 1.285 inches. In other embodiments, the length L2 of the body 510 may be less than 1.15 inches or greater than 1.45 inches. The drive pins 514 include a height H1 measured in a direction parallel to the longitudinal axis 106 that is less than a height of the drive pins 166 discussed above. In the illustrated embodiment, the height H1 of the drive pins 514 is between 0.1 inches and 0.15 inches. Specifically, the height H1 of the drive pins 514 are 0.112 inches. In other embodiments, the height H1 of the drive pins 514 may be less than 0.1 inches or greater than 0.15 inches. A ratio between the overall length L2 of the body 510 to the height H1 of the drive pins 514 is between 7.5 and 14.5. In other embodiments, the ratio between the overall length L2 of the body 510 to the height H1 of the drive pins 514 is between 10 and 12. In further embodiments, the ratio between the overall length L2 of the body 510 to the height H1 of the drive pins 514 is less than 4.5 or greater than 14.5. The ratio between the overall length L2 of the body 510 to the height H1 of the drive pins 514 is greater than 10.

Providing a cutting tool 10 with a pilot bit 14 that extends past a cutting end 30 of a hole saw 14 is imperative to guide the cutting tool into a workpiece. However, in some instances, for certain sized hole saws, the pilot bit 18 does not extend past the cutting end 30 of the hole saw 14. For example, for a 11/16″ hole saw, the cutting end 50 of the pilot bit 18 is recessed a distance 0.513 inches from the cutting end 30 of the hole saw 14. For a 1⅛″ hole saw, the cutting end 50 of the pilot bit 18 is recessed a distance 0.333 inches from the cutting end 30 of the hole saw 10. For a 1¼″ hole saw, the cutting end 50 of the pilot bit 18 is recessed a distance 0.095 inches from the cutting end 30 of the hole saw 14. However, for a 2.0 inch hole saw, the cutting end 50 of the pilot bit 18 extends past the cutting end 30 of the hole saw 14 a distance of 0.205 inches. In contrast, providing an arbor assembly including the combination of the adapter 200, the shank 400, and the sleeve 500 provides a cutting tool 10 with a pilot bit 18 that will extend past the cutting end 30 of a variety of different sized hole saws 14. Specifically, the shortened width W1 of the flange 218 and the shortened height H1 of the drive pins 514 allow the hole saw 14 to sit lower comparatively to the pilot bit 18. Additionally, the shortened depth D1 of the second portion 418 of the bore 410 allows the pilot bit 18 to extend further from the first end 94 of the shank 400 and past the cutting end 30 of the hole saw 14. As such, an arbor assembly with the adapter 200, the shank 400, and the sleeve 500 provides a cutting tool 10 with a pilot bit 18 that extends past the cutting end 30 of hole saws that have a diameter less than 2.0 inches. In further embodiments, the an arbor assembly with the adapter 200, the shank 400, and the sleeve 500 provides a cutting tool 10 with a pilot bit 18 that extends past the cutting end 30 of hole saws that have a diameter greater than 2.0 inches

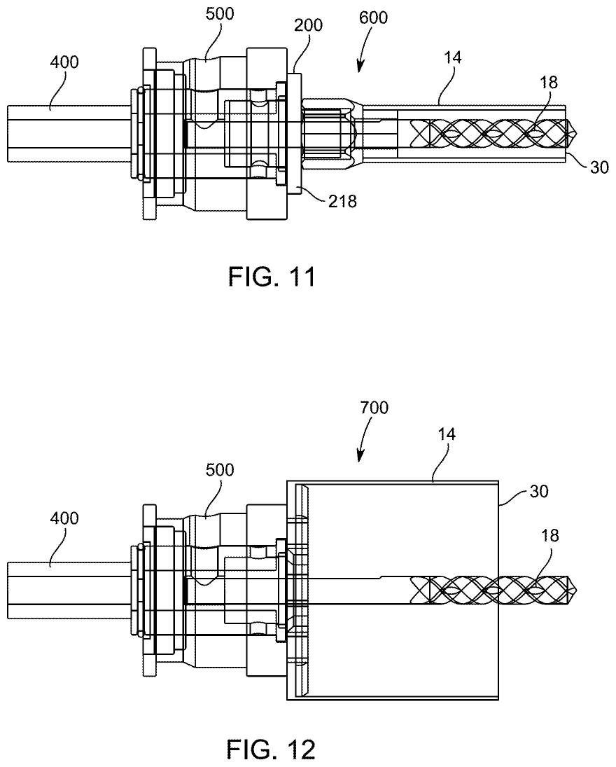

FIGS. 11 and 12 illustrate cutting tools 600, 700, respectively, with the modified components (e.g., adapter 200, shank 400, and sleeve 500) discussed above. In both FIGS. 11 and 12, the pilot bits 18 extends past the cutting end 30 of the hole saws 14 regardless of the diameter of the hole saw 14.

Various features and advantages of the invention are set forth in the following claims.

What is claimed is:

1. An arbor assembly for a hole saw and a pilot bit, the arbor assembly comprising:
a shank having a first end operable to be coupled to a power tool, a second end opposite the first end, and a longitudinal axis extending between the first and second ends, the shank including a groove and an aperture, the aperture being positioned between the groove and the second end;
a sleeve moveable relative to the shank along the longitudinal axis;
a locking member supported by the shank, the locking member configured to engage a hole saw or an adapter of the hole saw to selectively secure the hole saw to the arbor assembly;
a retaining ring supported by the groove of the shank to limit the axial movement of the sleeve relative to the shank; and
a fastener at least partially received in the aperture, the fastener configured to secure the pilot bit to the arbor assembly; and
wherein the sleeve is moveable relative to the shank between a first position, where the locking member secures the hole saw to the arbor assembly, and a second position, where the locking member releases the hole saw from the arbor assembly.

2. The arbor assembly of claim 1, wherein the shank further includes a bore defined in the second end, the bore configured to receive a portion of the pilot bit.

3. The arbor assembly of claim 2, wherein the bore includes a first portion with a first diameter, and wherein the bore includes a second portion adjacent the first portion with a second diameter that is smaller than the first diameter.

4. The arbor assembly of claim 1, wherein the sleeve moves toward the first end of the shank when moving from the first position to the second position.

5. The arbor assembly of claim 1, further comprising a spring that biases the sleeve toward the first position.

6. The arbor assembly of claim 1, wherein the locking member is a ball detent.

7. The arbor assembly of claim 1, wherein the sleeve includes a limiting groove that receives the locking member when in the second position.

8. The arbor assembly of claim 1, wherein the aperture is positioned a distance from the first end of the shank, the distance being less than 0.8 inches.

9. The arbor assembly of claim 8, wherein the groove is positioned a second distance from the first end of the shank, the second distance being greater than 1.0 inches.

10. A system comprising:
a first hole saw including a first cutting end and a first connection end opposite the first cutting end, the first hole saw having a first diameter that is equal to or greater than 2.0 inches;
a first adapter coupled to the first connection end of the first hole saw;
a second hole saw including a second cutting end and a second connection end opposite the second cutting end, the second hole saw defining a second diameter that is equal to or less than 1¼ inches;
a second adapter coupled to the second connection end of the second hole saw;
an arbor assembly including
a shank having a first end operable to be coupled to a power tool, a second end opposite the first end, and a longitudinal axis extending between the first and second ends, the second end alternately connectable to the first adapter and the second adapter,
a sleeve moveable relative to the shank, and
a locking member movable in response to movement of the sleeve, the locking member selectively engages the first adapter when the first adapter is connected to the shank to secure the first hole saw to the arbor assembly, and selectively engages the second adapter when the second adapter is connected to the shank to secure the second hole saw to the arbor assembly; and
a pilot bit coupled to the shank;
wherein the pilot bit extends past the first cutting end when the first adapter is coupled to the arbor assembly, and wherein the pilot bit extends past the second cutting end when the second adapter is coupled to the arbor assembly.

11. The system of claim 10, wherein the sleeve is moveable between a first position, where the locking member engages either the first or second adapter to secure the second or first adapter to the arbor assembly, and a second position, where the first locking member disengages the first or second adapter, allowing removal of the first or second adapter from the arbor assembly.

12. The system of claim 11, wherein the sleeve moves toward the first end of the shank when moving from the first position to the second position.

13. The system of claim 10, wherein the locking member is a ball detent.

14. The system of claim 10, wherein the first adapter is different from the second adapter.

15. A cutting tool comprising:
a hole saw;
an adapter coupled to the hole saw, the adapter including a first end, a second end opposite the first end, a longitudinal axis extending between the first and second ends, and a flange separating the first end from the second end, the adapter defining an overall length measured in a direction parallel to the longitudinal axis between the first and second ends, the flange defining a width measured in a direction parallel to the longitudinal axis; and
an arbor assembly including
a shank having a first end configured to be coupled to a power tool and a second end opposite the first end, the second end couples to the adapter, and
a sleeve moveable relative to the shank between a first position, in which the adapter is secured to the arbor assembly, and a second position, in which the adapter is removable from the arbor assembly;
wherein a ratio between the overall length of the adapter to the width of the flange is between 6 and 10.

16. The cutting tool of claim 15, wherein the overall length is less than 1.0 inches.

17. The cutting tool of claim 16, wherein the width is between 0.1 inches and 0.15 inches.

18. The cutting tool of claim 15, wherein the sleeve moves toward the first end of the shank when moving from the first position to the second.

19. The cutting tool of claim 15, wherein the arbor assembly further includes a locking member supported by the shank, the locking member engaging the adapter to selectively secure the adapter to the arbor assembly.

20. The cutting tool of claim 15, wherein the arbor assembly further includes a spring to bias the sleeve toward the first position.

21. An arbor assembly for a hole saw, the arbor assembly comprising:
a shank having a first end configured to be coupled to a power tool, a second end opposite the first end, and a longitudinal axis extending between the first and second ends, the second end configured to be coupled to the hole saw; and
a sleeve moveable relative to the shank along the longitudinal axis between a first position, in which the hole saw is secured to the arbor assembly, and a second position, in which the hole saw is removable from the arbor assembly, the sleeve including a body and a drive pin extending from the body, the drive pin configured to be received within an aperture of the hole saw, the body defining an overall length measured in a direction parallel to the longitudinal axis, the drive pin defining a height measured in a direction parallel to the longitudinal axis;
wherein a ratio between the overall length of the body to the height of the drive pin is greater than or equal to 10.

22. The arbor assembly of claim 21, wherein the height is between 0.1 inches and 0.15 inches.

23. The arbor assembly of claim 22, wherein the length is between 1.15 inches and 1.45 inches.

24. The arbor assembly of claim 21, wherein the sleeve moves toward the first end of the shank when moving from the first position to the second position.

25. The arbor assembly of claim 21, further comprising a locking member supported by the shank, the locking member configured to selectively secure the hole saw to the arbor assembly.

26. The arbor assembly of claim 21, further comprising a spring to bias the sleeve toward the first position.
